(19) United States
(12) Patent Application Publication
(10) Pub. No.: US 2010/0058106 A1
(43) Pub. Date: Mar. 4, 2010

(54) Virtual machine file system and incremental snapshot using image deltas

(75) Inventors: Kattiganehalli Y. Srinivasan, Princeton Junction, NJ (US); Ranjan K. Gupta, Salt Lake City, UT (US)

Correspondence Address: KING & SCHICKLI, PLLC, 247 NORTH BROADWAY, LEXINGTON, KY, 40507, US

(73) Assignee: Novell, Inc.

(21) Appl. No.: 12/229,870

(22) Filed: Aug. 27, 2008

(51) Int. Cl. G06F 11/14; G06F 9/455; G06F 17/30; G06F 12/02; G06F 15/177

(52) U.S. Cl. 714/2; 718/1; 707/1; 711/173; 713/2; 707/E17.01; 711/E12.002; 714/E11.136

(57) ABSTRACT

Methods and apparatus involve file systems for virtual machines and image deltas. Representatively, a plurality of virtual machines are configured on a hardware platform and a file system includes both a read-only portion and a writable portion that together provides the entire file system for each virtual machine. Also, a union of the two portions provides an incremental snapshot of its corresponding virtual machine and can be used to restore the virtual machine upon a failure event. In content, the read-only portion contains substantially immutable information such as core basic system image, while the writable portion contains configuration information, state data and production information. An available storage device for the virtual machines is partitioned for each virtual machine and its corresponding writable portion is found therein. Other features contemplate particular configurations and computer program products, to name a few.

### FIELD OF THE INVENTION

Generally, the present invention relates to computing devices and environments involving file systems and virtual machines. Particularly, although not exclusively, it relates to a sectioned or bifurcated file system in a virtual environment that provides protection from unexpected corruption and convenient restoration for the virtual machines. Other features contemplate actual configurations and computer program products, to name a few.

### BACKGROUND OF THE INVENTION

As presently exists, physical servers provide a myriad of services and most interact with a remote backup server to provide restoration services in the event of server failure. However, just as servers have a diversity of services, they also have a diversity of configuration, such as in their operating system, hardware device drivers, storage interfaces, file systems, applications, etc. Since backup is tightly correlated to these configurations, there are multiple products that serve to assist in backup. In that each is essentially configured to match the server's configuration, they do not transfer well to other servers having vastly different operating systems, storage interfaces, file systems, applications, etc.

With the advent of virtual computing devices, the foregoing complexity is only compounded because many virtual machines can be guested on a single hardware platform, including each with its own operating system, drivers, interfaces, applications, etc. In turn, conventional image snapshots are needed for each and every virtual machine to support backup and restoration according to the state of all the machines at any given point in time. The time must also be “early enough” to be interesting for each machine according to any number of reasons. For this, there are many incremental snapshot and back up algorithms available in the marketplace. However, there are shortcomings with each. For instance, restoring a complete file system for virtual machines makes for a time-consuming process, and exposes features to corruption that are otherwise unnecessary to restoration, (e.g., other virtual machines, the host domain (Dom0), baseline information, etc.).

Accordingly, a need exists in the art of computing backup and restoration for more convenient processes. In a computing environment of a multiple virtual machines per a single computing device, the need further extends to processes that can effectively isolate machines from one another and from unwanted exposure during restoration. Naturally, any improvements along such lines should further contemplate good engineering practices, such as ease of implementation, unobtrusiveness, stability, etc.

### SUMMARY OF THE INVENTION

The foregoing and other problems become solved by applying the principles and teachings associated with the hereinafter-described virtual machine file system and incremental snapshots via image deltas. At a high level, methods and apparatus involve the configuration of virtual machines on a hardware platform. A file system includes both a writable portion and a read-only portion whose union provides the entire file system for each virtual machine. In content, the read-only portion contains substantially immutable information such as core basic system image, while the writable portion contains configuration information, state data and production information, which updates or changes over time according to the usage of each virtual machine. In this manner, the writable portion can be updated for file, data, or other changes per each virtual machine, while the baseline read-only portion (which does not require any file, data or other updates) can be left in a consistent state and in a protected, or non-volatile location. Then, upon a failure event needing the restoration of a virtual machine, for example, only the writable portion needs restoration, not the read-only portion. Consequently, the read-only portion is protected from unexpected corruption, and since only the writable portion needs restoration, quicker and more convenient image restorations result per each virtual machine.

In hardware, a processor, memory and available storage exists for a physical platform, as is typical per virtual machine configuration, and the resources are allocated and controlled for conflicts via a virtual machine manager, such as a hypervisor. Preferably, but not required, the storage is partitioned to define each virtual machine's space, and its corresponding writable portion is embodied therein, including the management of the file system changes. A union of both the read-only and writable portion of the file system is generated by system boot code and is useful in providing accurate, incremental image snapshots to its corresponding virtual machine.

Executable instructions loaded on one or more computing devices for undertaking or assisting in the foregoing are also contemplated as are computer program products, available as a download or on a computer readable medium, having the executable instructions. The computer program products are also available for installation on a network appliance, individual computing devices, etc.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a representative diagrammatic view in accordance with the present invention for a virtual machine file system;

FIGS. 2A and 2B are diagrammatic views in accordance with the present invention for representatively locating the virtual machine file system; and

FIG. 3 is a flow chart in accordance with the present invention for various restoration and incremental image snapshot features.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for a virtual machine file system and incremental snapshots via image deltas.

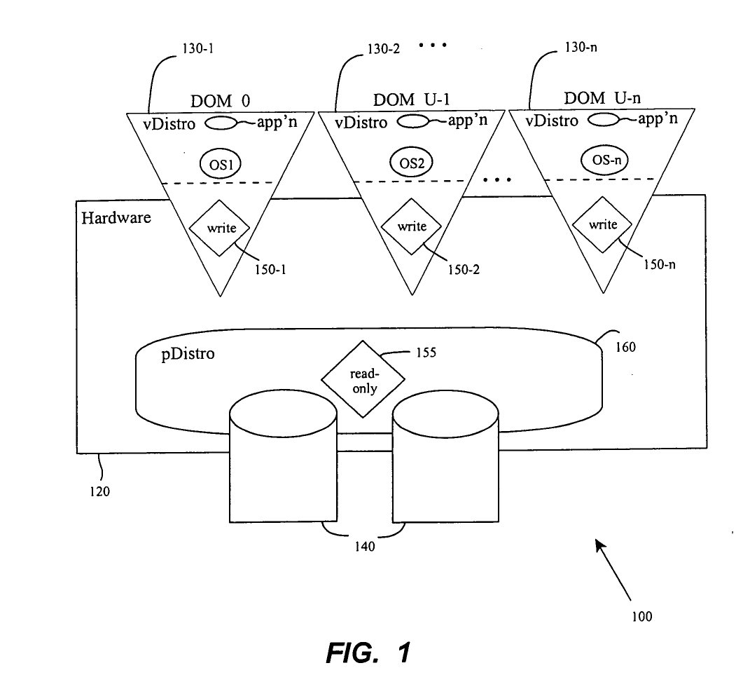

With reference to FIG. 1, a representative computing system environment 100 includes a hardware platform 120 hosting a variety of virtual machines 130-1, 130-2, . . . 130-n. In turn, each virtual machine includes its own guest operating system (OS-1, OS-2, . . . OS-n), dedicated applications (app'n), production data, etc. However, to effectively provide backup and restoration by way of available common storage 140 (volume), each virtual machine 130 has a file system comprised of a writable portion 150 and a read-only portion 155. Preferably, but not required, the read-only portion 155 stores substantially immutable information, such as core basic system image or any other information useful to the virtual machines that does not dynamically change in data, files, etc. as users utilize the virtual machines. On the other hand, the writable portion contains information that regularly changes with utilization of the virtual machines, such as configuration information, state data, application data, production information, or the like.

In this manner, the writable portion can be updated for file, data, or other changes per each virtual machine, while the read-only portion (which does not require any file, data or other updates) can provide a baseline of information for each virtual machine and be maintained in a consistent state in a protected location. Then, during use, such as upon a failure event needing the restoration of one of the virtual machines, for example, only the writable portion for the failed virtual machine needs restoration, not the read-only portion, and not the writable portions for the other virtual machines. Ultimately, the read-only portion is protected from unexpected corruption, and since only a writable portion needs restoration, quicker and more convenient image restorations result per each virtual machine. No longer is a monolithic file system required for the environment 100, which would be otherwise slower during restoration and, as before, exposes features to corruption that otherwise are unnecessary to the restoration process.

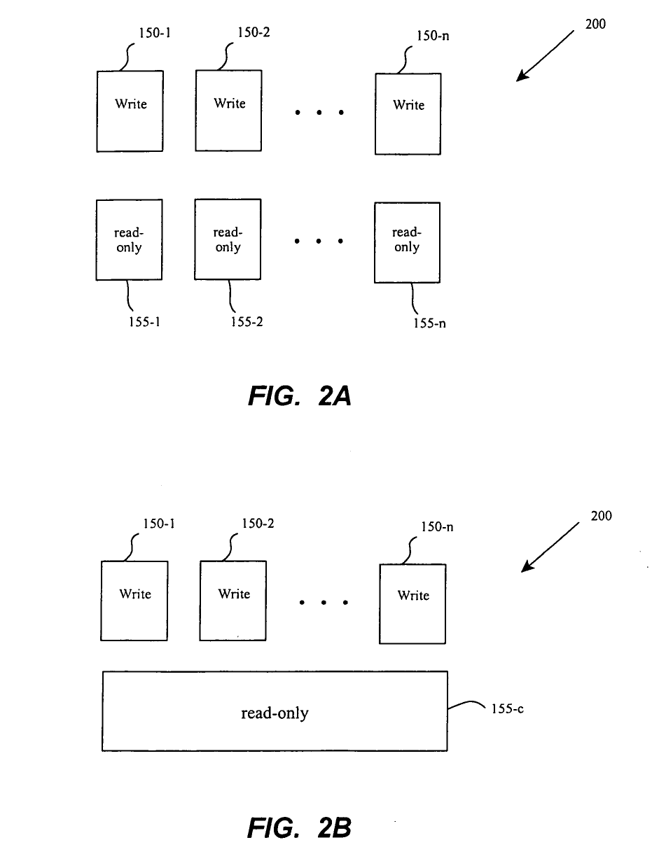

With reference to FIGS. 2A and 2B, more detail of the overall file system 200 shows one version (FIG. 2A) whereby the writable portions 150-1, 150-2, . . . 150-n are overlaid on a corresponding read-only portion 155-1, 155-2, . . . 155-n, and one version (FIG. 2B) whereby the writable portions 150 exist per a common read-only portion 155-c. In either however, the a full filesystem view is provided per any given virtual machine according to a union of the writable-portion and the read-only portion (either its corresponding dedicated read-only portion e.g., 150-2 combined together with 155-2, or 150-2 and its common read-only portion 155-c), without making any baseline or core operating system data writable. Also, skilled artisans will observe that the storage is partitioned in these figures to bound or define each virtual machine's space, as is typical with virtual machine representations, and its corresponding writable portion is embodied therein. Its read-only portion, on the other hand, is located typically in a separate partition, but also defined per each virtual machine's space in the situation whereby each has a corresponding read-only portion (FIG. 2A). Potentially, the virtual machines share the read-only portion (FIG. 2B) if they are multiple instances of the same image. For instance, if there are three virtual machines deployed that are each running an identical web serving software stack (e.g., Linux, Apache, MySQL and PEARL), then it is possible to have each of these virtual machines have the identical read-only partition. In either, the union of the writable portion and the read-only partition constitutes the full state of the system and a system boot code generates the required union.

To manage the file system, now in two parts, traditional techniques are contemplated. That is, the file system 200 still provides storage and organization of computer files per virtual machines to make it easier to later find and access them for restoration or other purposes. Alternatively, skilled artisans may consider the file system a special purpose computing device, such as a database, whereby data is stored, organized, navigated, accessed, retrieved, etc.

As such, the file system may further include directories to associate file names with files and may connect the names to an index in a file allocation table, such as FAT in DOS, or an inode in Unix. Directories may be organized in a variety of traditional or novel ways, such as in a hierarchy, in series, scale-free, etc. Sub-directories may also exist and names in either may have special syntax, extensions, version numbers, etc. File tags, or other devices, can be used and such representatively include: a length of data in a file (which can be stored as blocks, bytes, etc.); a time/timestamp that the file was last modified; a file's creation time; a file's last accessed time; a time that meta data in the file was changed; a file's type; a file's owner; and/or various access permissions, control lists, etc.

Returning to FIG. 1, the representative computing system environment can include a computing device in the form of a server. It can be of a traditional type, such as a grid or blade server, and can fulfill any future-defined or traditional role, such as a web server, email server, database server, file server, etc. In network, it is arranged to communicate with one or more other computing devices or networks, and skilled artisans readily understand the configuration. For example, the server may use wired, wireless or combined connections to other devices/networks and may be direct or indirect connections. If direct, they typify connections within physical or network proximity (e.g., intranet). If indirect, they typify connections such as those found with the internet, satellites, radio transmissions, or the like. In this regard, other contemplated items include other servers, routers, peer devices, modems, Tx lines, satellites, microwave relays or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

In configuration, the architecture of virtual machines can include a multiplicity of domains (dom0, domU-1 . . . domU-n) and a variety ofoperating systems (Host OS or Guest OS) (e.g., Linux, Windows, Netware, Unix, etc.). In turn, each can be configured on the hardware platform, with an intervening virtual machine monitor, such as a Xen or other hypervisor layer. Further, the hardware platform 120 embodies physical I/O and platform devices, memory and a processor, such as a CPU, Disk, USB, etc., while the hypervisor (which is the virtual interface to the hardware and virtualizes the hardware), is the lowest and most privileged layer and manages conflicts, for example, caused by operating system access to privileged machine instructions. The hypervisor can also be type 1 (native) or type 2 (hosted), and skilled artisans understand the terminology.

In addition, the pDISTRO is typically functionally configured specifically for the hardware platform and used to deploy physical machine specific hypervisors with drivers, agents, sound cards, etc., needed by specific hardware vendors. The virtual distribution, or vDISTRO, is used to deploy the virtual machines on the physical server and can move application stacks between them in real-time.

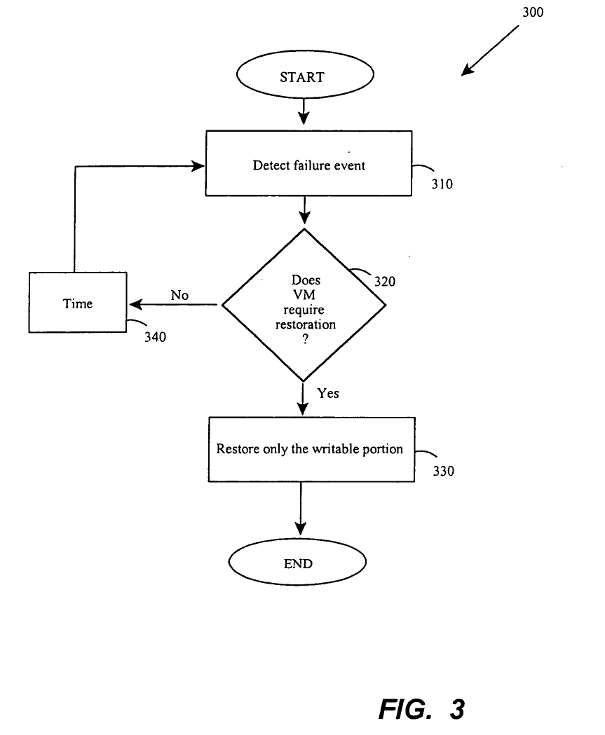

With reference to FIG. 3, the separately-apportioned file system having both a read-only and writable section is useful, as mentioned, to provide backup and restore functions. Namely, upon the detection of a failure event 310, a determination is made as to whether any, all or which ones of the virtual machines require restoration, step 320. In the event of restoration being required, it then occurs by restoring only the contents of the writable portion of the file system, step 330, not the remainder of the file system, e.g., the read-only portion. In other words, by having a writable portion relevant to a particular virtual machine, its current state is always representative of the latest incremental image snapshot of the virtual machine. On the other hand, the read-only portion is static and immutable. Thus, restoration only requires restoring the writable section, not the read-only section. In the event, however, the determination step 320 reveals that no virtual machine needs a restoration, the process repeats to step 310 to detect the next failure event after the passage of a relevant period of time, e.g., periodically, randomly, every x seconds, etc.

In any embodiment, skilled artisans will appreciate that enterprises can implement some or all of the foregoing with humans, such as system administrators, computing devices, executable code, or combinations thereof. In turn, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that components thereof, such as modules, routines, programs, objects, data structures, etc., perform particular tasks or implement particular abstract data types within various structures of the computing system which cause a certain function or group of function, and such are well known in the art.

Although the foregoing has been described in terms of specific embodiments, one of ordinary skill in the art will recognize that additional embodiments are possible without departing from the teachings of the present invention. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of other figures.

1. In a computing system environment, a method of storing and organizing computer files for a computing device having a hardware platform including a processor, memory and storage upon which a plurality of virtual machines are configured, comprising:
configuring a read-only file system on the hardware platform; and
configuring a writable file system for each of the virtual machines that together with the read-only file system provides the file system for said each of the virtual machines.

2. The method of claim 1, further including restoring one of the virtual machines by restoring only the contents of the writable file system corresponding to said one of the virtual machines.

3. The method of claim 1, wherein the configuring the read-only file system on the hardware platform further includes configuring a single read-only file system for more than one of said virtual machines.

4. The method of claim 1, further including obtaining an incremental snapshot of said virtual machines by examining a union of the read-only and writable file system.

5. The method of claim 1, wherein the configuring the writable file system further includes partitioning the storage of the hardware platform for the each said virtual machines, wherein said writable file system exists in a respective partition corresponding to its said each said virtual machine.

6. In a computing system environment, a method of obtaining incremental image snapshots for virtual machines configured on a hardware platform of a computing device including a processor, memory and storage, comprising:
configuring a read-only file system on the hardware platform;
configuring a writable file system for each of the virtual machines that together with the read-only file system provides the file system for said each of the virtual machines; and
determining a union of the read-only and writable file systems for any of the virtual machines needing the incremental image snapshot, the union being the incremental image snapshot.

7. The method of claim 6, further including restoring one of the virtual machines by restoring only the contents of the writable file system corresponding to said one of the virtual machines.

8. The method of claim 6, wherein the configuring the read-only file system on the hardware platform further includes configuring a single read-only file system for more than one of said virtual machines.

9. The method of claim 6, wherein the configuring the writable file system further includes partitioning the storage of the hardware platform for the each said virtual machines, wherein said writable file system exist in a respective partition corresponding to its said each said virtual machine.

10. In a computing system environment, a method of restoring an image of a virtual machine configured as one of a plurality of virtual machines on a hardware platform of a computing device having a processor, memory and storage, comprising:
separating a file system of the virtual machine into a read-only portion and a writable portion; and
upon a failure event requiring restoration of the virtual machine, restoring only the contents of the writable portion.

11. The method of claim 10, further including determining a union of the read-only portion and the writable portion, the union being an incremental snapshot of the image of the virtual machine.

12. The method of claim 10, wherein the separating the file system further includes configuring the read-only portion as a single read-only file system for more than one of said virtual machines.

13. The method of claim 10, wherein the separating the file system further includes partitioning the storage of the hardware platform for each of the virtual machines, said writable portion existing in a respective partition corresponding to its said each said virtual machine.

14. The method of claim 10, wherein the separating the file system further includes configuring the read-only portion to be readily available as an immutable portion of the file system.

15. A computing server, comprising:
a hardware platform, including a processor, memory and available storage;
a hypervisor layer on the hardware platform;
a plurality of virtual machines each operating as an independent guest computing device on the processor, memory and available storage by way of scheduling control from the hypervisor layer; and
a file system for each of the plurality of virtual machines, wherein the file system includes both a read-only portion and a writable portion that together provide the file system for said each of the virtual machines.

16. The computing server of claim 15, wherein the read-only portion is substantially immutable and includes executable files and shared libraries of the file system.

17. The computing server of claim 15, wherein, there is only a single read-only portion for more than one of the virtual machines.

18. The computing server of claim 15, wherein the available storage for the hardware platform is partitioned discretely for the each said virtual machines, wherein said writable portion exists in a respective partition corresponding to its said each said virtual machine.

19. The computing server of claim 15, further including system boot code installed on the hardware platform that generates a union of the read-only and writable portions, the union being an incremental image snapshot for the virtual machines.

20. A computer program product available as a download or on a computer readable medium for loading on a computing device in a computing system environment to organize computer files on a hardware platform thereof including a processor, memory and storage upon which a plurality of virtual machines are configurable, the computer program product having executable instructions to configure a file system of the virtual machines into a read-only portion and a writable portion that together provide the file system for each of the virtual machines.

21. The computer program product of claim 20, further including a second component of executable instructions to restore one of the virtual machines by restoring only the writable portion corresponding to said one of the virtual machines.

22. The computer program product of claim 20, further including a second component of executable instructions to configure the read-only portion as a single read-only portion for more than one of the virtual machines.

23. The computer program product of claim 20, further including a second component of executable instructions to obtain an incremental image snapshot of one of said virtual machines by examining a union of the read-only and writable portions.

24. The computer program product of claim 20, further including a second component of executable instructions to partition the storage of the hardware platform for each of the virtual machines, wherein said writable portion exists in a respective partition corresponding to its said each said virtual machine.

25. The computer program product of claim 20, further including a second component of executable instructions to load on the hardware platform to obtain a union of the writable portion and the read-only portion for any of the virtual machines.
